(19) United States
(12) Patent Application Publication
(10) Pub. No.: US 2019/0370902 A1
(43) Pub. Date: Dec. 5, 2019

(54) METHOD FOR PRICE PREDICTION OF FINANCIAL PRODUCTS BASED ON DEEP LEARNING MODEL

(71) Applicant: SHINE WE DEVELOPMENT INC., Taipei City (TW)

(72) Inventors: Shang-Jyh Yiin, Taipei City (TW); Chih-Ming Lai, Taoyuan City (TW); Da-Wei Liu, Taipei City (TW); Che-Yu Chuang, Taipei City (TW)

(21) Appl. No.: 16/425,861

(22) Filed: May 29, 2019

Related U.S. Application Data
(60) Provisional application No. 62/678,238, filed on May 30, 2018.

(51) Int. Cl. G06Q 40/06; G06K 9/62; G06T 11/20; G06N 3/08; G06F 17/16; G06T 17/00

(52) U.S. Cl. CPC G06Q 40/06; G06K 9/6257; G06T 17/00; G06N 3/08; G06F 17/16; G06T 11/206

(57) ABSTRACT

A deep learning method for predicting at least one future price of a financial product includes generating a plurality of candlesticks over historical trading data of the financial product, inputting the plurality of candlesticks to a neural network machine, the neural network machine processing the plurality of candlesticks to generate a trained neural network model, and a neural network predicting machine predicting the at least one future price of the financial product according to the trained neural network model.

### CROSS REFERENCE TO RELATED APPLICATIONS

This application claims the benefit of U.S. Provisional application No. U.S. 62/678,238, filed May 30, 2018 which is incorporated herein by reference.

### BACKGROUND OF THE INVENTION

### 1. Field of the Invention

The invention is related to machine learning method, and more particularly, to implement a neural network for price prediction of financial products.

### 2. Description of the Prior Art

There are mainly two types of stock market analysis, one is basic analysis, and the other is technical analysis.

The basic analysis focuses on international and political events, macroeconomic environment, industrial status, and individual company status. In international and political events, the influencing factors include war, natural disasters, man-made disasters, international sanctions, international conferences or negotiations, the collapse of large international financial institutions, government policies and interventions, elections, legislation, comprehensive strikes, etc. In macroeconomic environment, the influencing factors include income, interest rates, exchange rates, consumer price index, oil prices, and tax rates. In industrial status, the influencing factors include the industry category, the life cycle of the industry, etc. In individual company status, the influencing factors include the financial statements of the company and individual events of the company.

The technical analysis can be a pattern analysis. The pattern analysis can be implemented by converting historical stock prices into graphs for reviewing stock price trend. For example, a candlestick can indicate the opening price, the highest price, the lowest price, and the closing price of a time period. Through the candlestick, we can evaluate the buying and selling strengths of the stock. In another example, we can predict the future trend according to the patterns generated from the historical graphs. When a graph is forming a certain pattern, we can use the pattern to predict the future stock price trend. Examples of pattern analysis are Dow theory, Elliott wave theory, and J. Granville's moving average principle.

Based on the technical analysis, there are different machine-learning methods applied in predicting a financial product's trend, including feature learning, decision tree, association rules, and linear regression, etc. The most popular machine learning method is linear regression method for time series. However, the traditional machine learning method may be trapped in calculating local maximum or minimum, however this will have too many outliers, and will cause a high operation dimension.

### SUMMARY OF THE INVENTION

An embodiment discloses a deep learning method for predicting at least one future price of a financial product. The method comprises generating a plurality of candlesticks over trading data of the financial product, inputting the plurality of candlesticks to a neural network machine, the neural network machine processing the plurality of candlesticks to generate a trained neural network model, and a neural network predicting machine predicting the at least one future price of the financial product according to the trained neural network model.

Another embodiment discloses a deep learning method for predicting at least one future price of a financial product. The method comprises generating a plurality of candlesticks over trading data of the financial product, inputting the plurality of candlesticks and a plurality of corresponding volumes of the financial product to a neural network machine, the neural network machine processing the plurality of candlesticks and the plurality of corresponding volumes of the financial product to generate a trained neural network model, and a neural network predicting machine predicting the at least one future price of the financial product according to the trained neural network model.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for generating a plurality of candlesticks according to an embodiment.

FIG. 2 is a flowchart of a method for generating trained neural network model according to an embodiment.

FIG. 3 is a flowchart of a method performed by the encoder in step S206 according to an embodiment.

FIG. 4 illustrates a convolution operation.

FIG. 5 illustrates a dilation operation.

FIG. 6 is a flowchart of a method performed by the decoder in step S208 according to an embodiment.

FIG. 7 illustrates an embodiment of a block diagram of classifier.

FIG. 8 is a flowchart of a method for predicting future prices of a financial product.

### DETAILED DESCRIPTION

The present invention provides a deep learning method by neural network for predicting future prices of a financial product. The method uses past financial product' data to predict the future prices of the financial product. The invention includes 3 major parts, graphical data generation, artificial intelligence (AI) model training, and forecast of the future prices of the financial product.

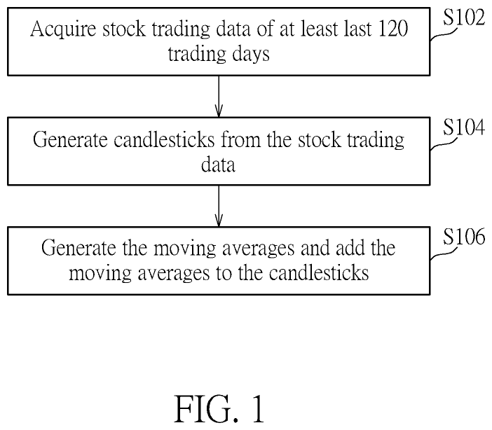

FIG. 1 is a flowchart of a method for generating a plurality of candlesticks according to an embodiment. The method comprises the following steps:

Step S102: acquire stock trading data of at least last 120 trading days. The stock trading data includes an opening price, highest price, lowest price, closing price, and trading volume of each trading day;

Step S104: generate candlesticks from the stock trading data. A Candlestick chart is composed of a plurality of candlesticks. A candlestick composes a body (green or red), an upper shadow and a lower shadow (wick). The area between the opening price and the closing price is called the real body, price excursions above and below the real body are shadows. The wick illustrates the highest and lowest traded prices of an asset during the time interval represented. The body (green or red) illustrates the opening price and the closing price. The embodiment uses trading data of last 120 trading days, so a candlestick chart composed of 120 candlesticks is generated;

Step S106: generate the moving averages and add the moving averages to the candlesticks. The moving averages are generated according to daily closing prices. Different moving averages may include five-day, twenty-day, sixty-day, one-hundred-day and two-hundred-and-forty-day moving averages. In each moving average, x-axis is used to indicate time, y-axis is used to indicate the average price of a predetermined period of time.

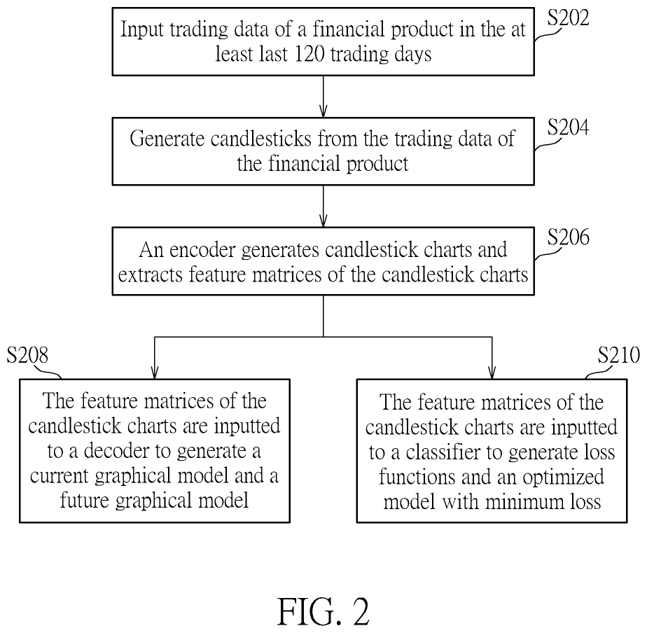

FIG. 2 is a flowchart of a method for generating trained neural network model according to an embodiment. The method comprises the following steps:

Step S202: input trading data of a financial product in the at least last 120 trading days. The stock trading data includes an opening price, highest price, lowest price, closing price, and trading volume of each trading day;

Step S204: generate candlesticks from the trading data of the financial product;

Step S206: an encoder generates candlestick charts and extracts feature matrices of the candlestick charts;

Step S208: the feature matrices of the candlestick charts are inputted to a decoder to generate a current graphical model and a future graphical model. The decoder outputs the current graphical model and the future graphical model;

Step S210: the feature matrices of the candlestick charts are inputted to a classifier to generate loss functions and an optimized model with minimum loss. The classifier outputs the optimized model.

The candlestick charts of step S206 are 2 dimensional candlestick charts each with a red gray level, a green gray level and a blue gray level (RGB). To reduce computational complexity, the encoder can further convert the candlestick charts to embedded vectors. For example, a candlestick chart is a 1200×50 image with (RGB) color. The candlestick chart is embedded to a 1200×50×24 3-dimensional image and then be converted to an embedded vector. The encoder can extract feature matrices from a plurality of embedded vectors.

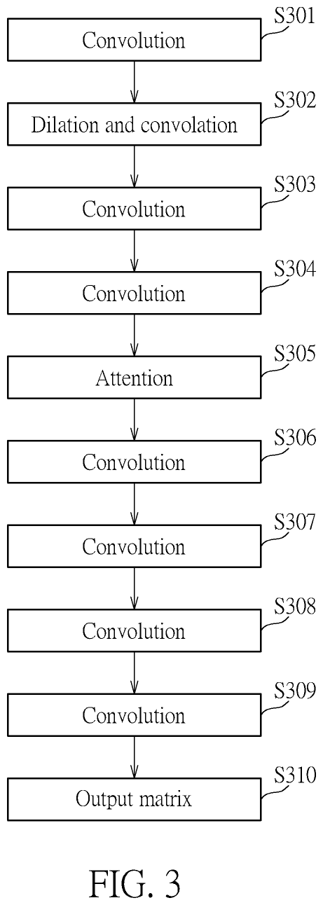

FIG. 3 is a flowchart of a method performed by the encoder in step S206 according to an embodiment. The encoder extracts feature matrices of candlestick charts by using S layers of convolution neural network architecture, where S is an integer. Further dilation and convolution are performed in the i-th layer, an attention operation is performed in the j-th layer, where i, j are integers and i, j are less than S. The encoder can be used to perform the following steps:

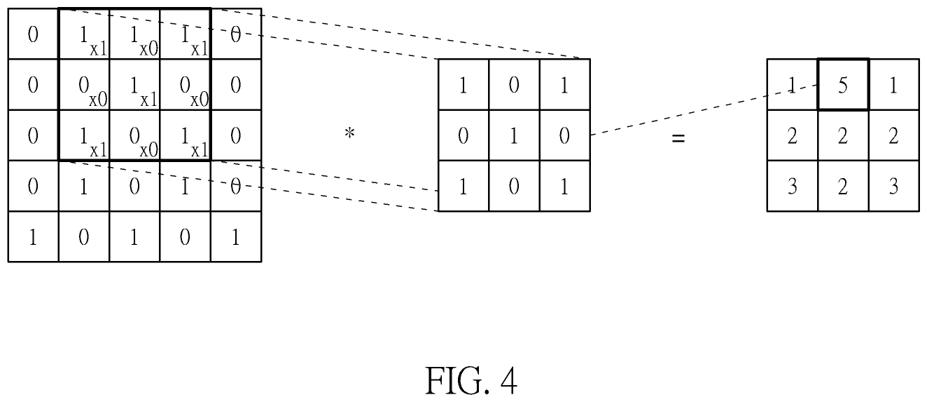

Step S301: perform a convolution operation over an a1×a2 matrix. FIG. 4 illustrates a convolution operation. First, select an element on the a1×a2 matrix, and extract an n1×n1 matrix centered at the element. Render each element of the n1×n1 matrix a weight. Multiply each element of the n1×n1 matrix by its corresponding weight to form a product, and add all products up to generate a value of the element. This process is performed for all elements in the input matrix which can be a center of an n1×n1 matrix, thereby generating an a3×a4 matrix where a3=a1−n1+1, a4=a2−n1+1;

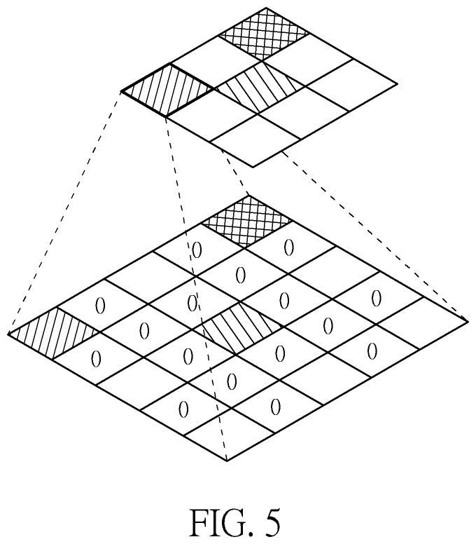

Step S302: perform a dilation and convolution operation over the a3×a4 matrix. FIG. 5 illustrates the dilation operation. Generate an n2×n2 matrix and render each element of the n2×n2 matrix a weight wherein n2 is a positive integer. The n2×n2 matrix is expanded to become a (k*n2−k+1)×(k*n2−k+1) matrix wherein k is a positive integer. The element at (x,y) in the n2×n2 matrix is disposed at (kx−k+1,ky−k+1) in the (k*n2−k+1)×(k*n2−k+1) matrix. For example, the element at (1,1) in the n2×n2 matrix is disposed at (1,1) in the (k*n2−k+1)×(k*n2−k+1) matrix. The element at (2,3) in the n2×n2 matrix is disposed at (k+1,2k+1) in the (k*n2−k+1)×(k*n2−k+1) matrix. Zeros are inserted to all columns which are not (ik+1) th columns of the (k*n2−k+1)×(k*n2−k+1) matrix, and inserted to all rows which are not (ik+1) th rows of the (k*n2−k+1)×(k*n2−k+1) matrix where i={0, . . . , n2−1}. After the dilation operation, perform the convolution operation as step S301. Select an element on the a3×a4 matrix, and extract the (k*n2−k+1)×(k*n2−k+1) matrix centered at the element. Multiply each element of the (k*n2−k+1)×(k*n2−k+1) matrix by its corresponding weight to form a product, and add all products up to generate a value of the element. This process is performed for all elements in the a3×a4 matrix which can be a center of an (k*n2−k+1)×(k*n2−k+1) matrix, thereby generating an a5×a6 matrix where a5=a3−k*n2+k, a6=a4−k*n2+k;

Step S303: perform a convolution operation over the a5×a6 matrix. FIG. 4 illustrates a convolution operation. First, select an element on the a5×a6 matrix, and extract an n3×n3 matrix centered at the element wherein n3 is a positive integer. Render each element of the n3×n3 matrix a weight. Multiply each element of the n3×n3 matrix by its corresponding weight to form a product, and add all products up to generate a value of the element. This process is performed for all elements in the a5×a6 matrix which can be a center of an n3×n3 matrix, thereby generating an a7×a8 matrix where a7=a5−n3+1, a8=a6−n3+1;

Step S304: perform a convolution operation over the a7×a8 matrix. First, select an element on the input matrix, and extract an n4×n4 matrix centered at the element. Render each element of the n4×n4 matrix a weight. Multiply each element of the n4×n4 matrix by its corresponding weight to form a product, and add all products up to generate a value of the element. This process is performed for all elements in the a7×a8t matrix which can be a center of an n4×n4 matrix, thereby generating an a9×a10 matrix where a9=a7−n4+1, a10=a8−n4+1;

Step S305: perform an attention operation over the a9×a10 matrix. Multiply the a9×a10 matrix by constants z1, z2, z3 to generate matrices A1, A2, and A3 respectively. Then multiply matrix A1 by the transpose of matrix A2 to generate a matrix A4 which is an a9×a9 matrix. The matrix A4 is converted to an attention map A5 by a softmax operation. The attention map A5 is an a9×a9 matrix. Multiply the matrix A5 by matrix A3 to generate a matrix A6 which is an a9×a10 matrix;

Step S306: perform a convolution operation over the matrix A6. First, select an element on the matrix A6, and extract an n5×n5 matrix centered at the element. Render each element of the n5×n5 matrix a weight. Multiply each element of the n5×n5 matrix by its corresponding weight to form a product, and add all products up to generate a value of the element. This process is performed for all elements in the matrix A6 which can be a center of an n6×n6 matrix, thereby generating an a11×a12 matrix where a11=a9−n5+1, a12=a10−n5+1;

Step S307: perform a convolution operation over the a11×a12 matrix. First, select an element on the a11×a12 matrix, and extract an n6×n6 matrix centered at the element. Render each element of the n6×n6 matrix a weight. Multiply each element of the n6×n6 matrix by its corresponding weight to form a product, and add all products up to generate a value of the element. This process is performed for all elements in the a11×a12 matrix which can be a center of an n6×n6 matrix, thereby generating an a13×a14 matrix where a13=a11−n6+1, a14=a12−n6+1;

Step S308: perform a convolution operation over the a13×a14 matrix. First, select an element on the a13×a14 matrix, and extract an n7×n7 matrix centered at the element. Render each element of the n7×n7 matrix a weight. Multiply each element of the n7×n7 matrix by its corresponding weight to form a product, and add all products up to generate a value of the element. This process is performed for all elements in the a13×a14 matrix which can be a center of an n7×n7 matrix, thereby generating an a15×a16 matrix where a15=a13−n7+1, a16=a14−n7+1;

Step S309: perform a convolution operation over the a15×a16 matrix. First, select an element on the a15×a16 matrix, and extract an n8×n8 matrix centered at the element. Render each element of the n8×n8 matrix a weight. Multiply each element of the n8×n8 matrix by its corresponding weight to form a product, and add all products up to generate a value of the element. This process is performed for all elements in the a15×a16 matrix which can be a center of an n8×n8 matrix, thereby generating an a17×a18 matrix where a17=a15−n8+1, a18=a16−n8+1;

Step S310: multiply the a17×a18 dimensional matrix by a constant 2 to generate an output matrix A10 which is an a17×a18 matrix.

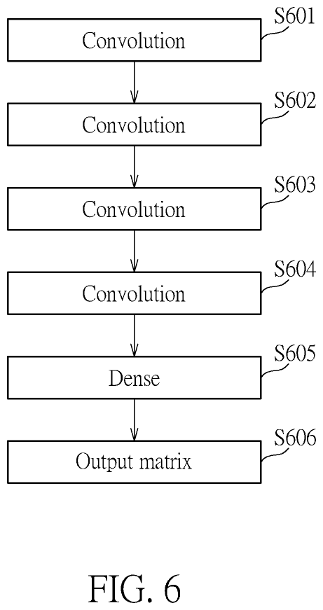

FIG. 6 is a flowchart of a method performed by the decoder in step S208 according to an embodiment. The decoder can be used to generate the current graphical model and the future graphical model according to the following steps:

Step S601: perform a convolution operation over the matrix A10 outputted from step S310. First, select an element on the matrix A10, and extract an n9×n9 matrix centered at the element. Render each element of the n9×n9 matrix a weight. Multiply each element of the n9×n9 matrix by its corresponding weight to form a product, and add all products up to generate a value of the element. This process is performed for all elements in the matrix A10 which can be a center of an n9×n9 matrix, thereby generating an a19×a20 matrix where a19=a17−n9+1, a20=a18−n9+1;

Step S602: perform a convolution operation over the a19×a20 matrix. First, select an element on the a19×a20 matrix, and extract an n10×n10 matrix centered at the element. Render each element of the n10×n10 matrix a weight. Multiply each element of the n10×n10 matrix by its corresponding weight to form a product, and add all products up to generate a value of the element. This process is performed for all elements in the a19×a20 matrix which can be a center of an n10×n10 matrix, thereby generating an a21×a22 matrix where a21=a19−n10+1, a22=a20−n10+1;

Step S603: perform a convolution operation over the a21×a22 matrix. First, select an element on the a21×a22 matrix, and extract an n11×n11 matrix centered at the element. Render each element of the n11×n11 matrix a weight. Multiply each element of the n11×n11 matrix by its corresponding weight to form a product, and add all products up to generate a value of the element. This process is performed for all elements in the a21×a22 matrix which can be a center of an n11×n11 matrix, thereby generating an a23×a24 matrix where a23=a21−n11+1, a24=a22−n11+1;

Step S604: perform a convolution operation over the a23×a24 matrix. First, select an element on the a23×a24 matrix, and extract an n12×n12 matrix centered at the element. Render each element of the n12×n12 matrix a weight. Multiply each element of the n12×n12 matrix by its corresponding weight to form a product, and add all products up to generate a value of the element. This process is performed for all elements in the a23×a24 matrix which can be a center of an n12×n12 matrix, thereby generating an a25×a26 matrix where a25=a23−n12+1, a26=a24−n12+1;

Step S605: perform a dense operation over the a25×a26 matrix. The dense operation is a fully-connected operation of a neural network. First, convert the a25×a26 matrix to a vector V with a length of dim=25*26=650. Then execute the sub-steps as shown below: Sub-step 1: generate dim×b1 matrix B11, b1×b2 matrix B12, to b (k*(n−1))×b(k*n) matrix Bn wherein k and n are positive integers. Multiply the vector V by matrix B11 to generate a vector V1, multiply the vector V1 by the matrix B12 to generate a vector V2, until multiply a vector V (k−1) by a matrix B1k to generate a vector Vₖ. Sub-step 2: Execute a matrix operation of the vectors V and Vₖ to generate a vector V_{f}. Sub-step 3: recursively perform sub-step 1 and sub-step 2 to generate an a1×a2 matrix;

Step S606: multiply the a1×a2 matrix in step S605 by a constant q to generate an output matrix B which is an a1×a2 matrix.

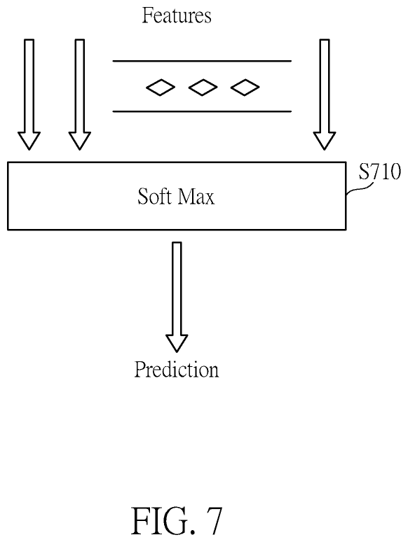

FIG. 7 illustrates an embodiment of a block diagram of a classifier 710. The matrix A10 from step S310 is inputted into a classifier 710. The matrix A10 is an a17×a18 matrix. The classifier 710 performs a softmax operation to generate a probability vector P where k is an integer and P=(p1, . . . , pk). Then the following steps are performed:

Step 701: Calculate an Euler distance R1 of the matrix B outputted from step S606 and the a1×a2 matrix in step S301;

Step 702: Calculate an Euler distance R2 of the matrix B outputted from step S606 and an expected matrix;

Step 703: Use the value D(i,j) of the (i,j) point of the matrix B and the value O (i,j) of the (i,j) point of the a1×a2 matrix in step S301 to generate an output r₁(i,j) as expressed in equation 1.

r₁(i,j)=D(i,j)×ln [D(i,j)/O(i,j)] equation 1

Add all r₁(i,j) values to generate a value R3;

Step 704: Use the value D(i,j) of the (i,j) point of the matrix B and the value F (i,j) of the (i,j) point of the expected matrix to generate an output r₂(i,j) as expressed in equation 2.

r₂(i,j)=D(i,j)×ln [D(i,j)/F(i,j)] equation 2

Add all the r₂(i,j) values to generate a value R4;

Step 705: The probability vector P=(p1, . . . , pk) of the classifier and the actual vector T=(t1, . . . , tk) are used to perform the following sub-steps:
a. Let P1=(p1*t1, . . . , pk*tk);
b. Let P2=(p1*(1−t1), . . . , pk*(1−tk));
c. Let P11=(1−p1*t1, . . . , 1−pk*tk)=(p11, . . . , p1k). If a value of p11 to p1k is larger than 1, assign the value to be 1. If a value of p11 to p1k is smaller than 0, assign the value to be 0;
d. Let P12=(p1*(1−t1)+1−p1*t1, . . . , pk*(1−tk)+1−pk*tk)=(p21, . . . , p2k). If a value of p21 to p2k is larger than 1, assign the value to be 1. If a value of p21 to p2k is smaller than 0, assign the value to be 0;
e. Let P13=(p1*(1−t1)−1, . . . , p1*(1−tk)−1)=(p31, . . . , p3k). If a value of p31 to p3k is larger than 1, assign the value to be 1. If a value of p21 to p2k is smaller than 0, assign the value to be 0;
f. Generate a value R5 by averaging corresponding elements of P11, P12 and P13 and summing all averaged elements;

Step 706: Calculate P=(p1, . . . , pk) and T=(t1, . . . , tk) to generate a cross entropy Q1. Assign a constant gamma. Let P14=(t1*(1−p1)²*ln(p1), . . . , tk*(1−pk)^{gamma}*ln(pk)). Calculate the average of all elements of P14 to generate Q2. Then calculate Q1−Q2 to generate R6;

Step 707: Let OP=R1+R2+R3+R4+R5+R6, and optimize the result by Cognitive Toolkit ADAM to generate an optimized model.

Adaptive Moment Estimation(Adam) is an algorithm for adaptive learning which not only combines the benefits of Nesterov accelerated gradient and Momentum but also optimizes them. It also divides the learning rate by an attenuation of the exponential decay. The reason is that after training several times, the loss function will be closer to the goal minimum. Thus, the learning rate (η) should be smaller than the initial value.

In each updating step, a different learning rate ηᵢ is used for each model parameter θᵢ. In the t-th update step, the parameter θᵢ gradient of the objective function is g_{t,i}:

g_{t,i}=∇_{θ}J(θᵢ) (7.1)

Vₜ is the average square gradient of the exponential decay, Mₜ is the exponential decay mean of historical gradient:

mₜ=β₁mₜ₋₁+(1−β₁)gₜ (7.2)

vₜ=β₂vₜ₋₁+(1−β₂)gₜ² (7.3)

The deviations are offset by calculating the first and second moments of the deviation correction:

$$\begin{matrix}= \frac{{m}_{t}}{1 - {β}_{1}^{t}} & ( 7.4 ) \\ = \frac{{v}_{t}}{1 - {β}_{2}^{t}} & ( 7.5 )\end{matrix}$$

Using the above equations to update the parameters, we can get the Adaptive Moment Estimation function as follows:

$${θ}_{t + 1} = {θ}_{t} - \frac{η}{\sqrt{} + ɛ} \qquad ( 7.6 )$$

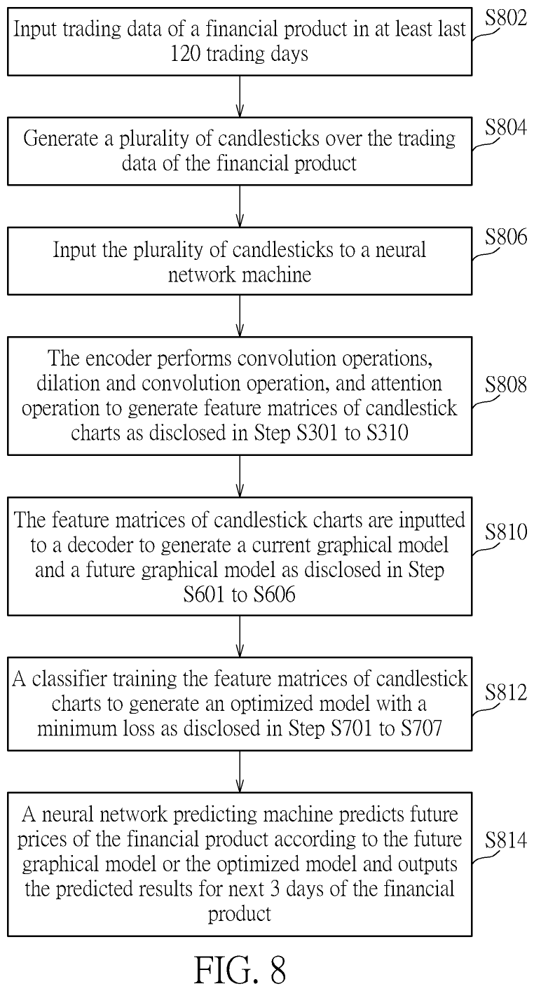

FIG. 8 is a flowchart of a method for predicting future prices of a financial product. The method comprises the following steps:

Step S802: input trading data of a financial product in at least last 120 trading days. The stock trading data includes an opening price, highest price, lowest price and closing price of each trading day;

Step S804: generate a plurality of candlesticks over the trading data of the financial product;

Step S806: input the plurality of candlesticks to a neural network machine;

Step S808: the encoder performs convolution operations, dilation and convolution operation, and attention operation to generate feature matrices of candlestick charts as disclosed in Step S301 to S310;

Step S810: the feature matrices of candlestick charts are inputted to a decoder to generate a current graphical model and a future graphical model as disclosed in Step S601 to S606;

Step S812: a classifier training the feature matrices of candlestick charts to generate an optimized model with a minimum loss as disclosed in Step S701 to S707;

Step S814: a neural network predicting machine predicts future prices of the financial product according to the future graphical model or the optimized model and outputs the predicted results for next 3 days of the financial product.

The embodiment provides a method for predicting at least one future price of a financial product. The neural network machine comprises an encoder for generating candlestick charts and extracting feature matrices of the candlestick charts from embedded vectors converted from the plurality of candlestick charts, a decoder for generating a current graphical model and a future graphical model according to the feature matrices of the candlestick charts, and a classifier for training the feature matrices of the plurality of candlestick charts to generate an optimized model with a minimum loss. The trained neural network model includes the current graphical model, the future graphical model, and the optimized model. The generated future graphical model and the optimized model can be used to predict future prices of financial products. Furthermore, the generated graphical model and the optimized model can be used in different financial products. For example, the stock optimized model can be used in predicting future prices of currency, virtual currency etc. The embodiment can keep renewing the optimized model by newly inputted candlesticks to increase the predictive accuracy of the optimized model. Furthermore, volumes corresponding to the plurality of candlesticks can also be inputted to the neural network machine. The trained neural network model can be generated by processing the plurality of candlesticks and the plurality of corresponding volumes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A deep learning method for predicting at least one future price of a financial product, the method comprising:
generating a plurality of candlesticks over trading data of the financial product;
inputting the plurality of candlesticks to a neural network machine;
the neural network machine processing the plurality of candlesticks to generate a trained neural network model; and
a neural network predicting machine predicting the at least one future price of the financial product according to the trained neural network model.

2. The method of claim 1, wherein the financial product is:
stock, bond, commodity, currency, index, cryptocurrency, or derivative financial product.

3. The method of claim 1, wherein each candlestick comprises:
an opening price, a closing price, a highest price and a lowest price.

4. The method of claim 1, wherein the plurality of candlesticks are:
hourly candlesticks, daily candlesticks, weekly candlesticks or monthly candlesticks.

5. The method of claim 1, wherein the neural network predicting machine predicting the at least one future price of the financial product according to the trained neural network model is:
the neural network predicting machine predicting a plurality of hourly, daily, weekly or monthly continuous future prices of the financial product according to the corresponding trained neural network model.

6. The method of claim 1, wherein the neural network machine processing the plurality of candlesticks to generate the trained neural network model comprises:
an encoder generating candlestick charts and extracting feature matrices of the candlestick charts from the plurality of candlesticks;
a decoder generating a current graphical model and a future graphical model according to the feature matrices of the candlestick charts; and
a classifier training the feature matrices of the candlestick charts to generate an optimized model with a minimum loss; and
wherein the trained neural network model includes the current graphical model, the future graphical model, and the optimized model.

7. The method of claim 6 further comprising:
inputting the optimized model to the encoder.

8. The method of claim 6, wherein the encoder generating the candlestick charts is:
the encoder generating the candlestick charts each from 10 continuous candlesticks of the plurality of candlesticks.

9. The method of claim 6, wherein the candlestick charts are 2 dimensional candlestick charts each with a red gray level, a green gray level and a blue gray level, and the neural network machine processing the plurality of candlesticks to generate the trained neural network model further comprises:
the encoder converting each 2 dimensional candlestick chart to a 3 dimensional candlestick chart; and
the encoder converting the 3 dimensional candlestick chart to an embedded vector.

10. The method of claim 6, further comprising restoring the candlestick charts according to the current graphical model.

11. The method of claim 6, further comprising predicting following candlestick charts according to the future graphical model.

12. The method of claim 6, wherein the classifier training the feature matrices of the candlestick charts to generate the optimized model with the minimum loss is:
the classifier training the feature matrices of the candlestick charts to generate the optimized model with the minimum loss according to price rise, price drop and price unchanged of the financial product.

13. The method of claim 6, wherein the classifier training the feature matrices of the candlestick charts to generate the optimized model with the minimum loss is:
the classifier training the feature matrices of the candlestick charts to generate the optimized model with the minimum loss according to 13 price fluctuation ranges of the financial product.

14. The method of claim 6, wherein the classifier training the feature matrices of the candlestick charts to generate the optimized model with the minimum loss is:
the classifier repeatedly training the feature matrices of the candlestick charts to generate the optimized model with the minimum loss by performing Adaptive Moment Estimation (ADAM) Optimization.

15. The method of claim 1, further comprising inputting at least 10 candlesticks to the optimized model for predicting future prices of the financial product.

16. A deep learning method for predicting at least one future price of a financial product, the method comprising:
generating a plurality of candlesticks over trading data of the financial product;
inputting the plurality of candlesticks and a plurality of corresponding volumes of the financial product to a neural network machine;
the neural network machine processing the plurality of candlesticks and the plurality of corresponding volumes of the financial product to generate a trained neural network model; and
a neural network predicting machine predicting the at least one future price of the financial product according to the trained neural network model.

17. The method of claim 16, wherein the neural network machine processing the plurality of candlesticks and the plurality of corresponding volumes of the financial product to generate the trained neural network model comprises:
an encoder generating candlestick charts and extracting feature matrices of the candlestick charts from the plurality of candlesticks;
a decoder generating a current graphical model and a future graphical model according to the feature matrices of the candlestick charts; and
a classifier training the feature matrices of the candlestick charts to generate an optimized model with a minimum loss; and
wherein the trained neural network model includes the current graphical model, the future graphical model, and the optimized model.

18. The method of claim 17, wherein the encoder generating the candlestick charts is:
the encoder generating the candlestick charts each from 10 continuous candlesticks of the plurality of candlesticks.

19. The method of claim 17, wherein the candlestick charts are 2 dimensional candlestick charts each with a red gray level, a green gray level and a blue gray level, and the neural network machine processing the plurality of candlesticks and the plurality of corresponding volumes of the financial product to generate the trained neural network model further comprises:
the encoder converting each 2 dimensional candlestick chart to a 3 dimensional candlestick chart; and
the encoder converting the 3 dimensional candlestick chart to an embedded vector.
